(19) United States
(12) Patent Application Publication
(10) Pub. No.: US 2009/0254982 A1
(43) Pub. Date: Oct. 8, 2009

(54) METHODS, PROGRAMS AND A SYSTEM OF PROVIDING REMOTE ACCESS

(75) Inventors: Peter Gerardus Jansen, Eindhoven (NL); Bob Janssen, Lage Zwaluwe (NL)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: REAL ENTERPRISE SOLUTIONS DEVELOPMENT B.V., 'S-HERTOGENBOSCH (NL)

(21) Appl. No.: 12/440,306

(22) PCT Filed: Oct. 23, 2006
(86) PCT No.: PCT/EP2006/067661

§ 371 Date: Mar. 6, 2009

(51) Int. Cl. H04L 9/32; G06F 21/20

(52) U.S. Cl. 726/8; 726/5

(57) ABSTRACT

The invention relates to a method of providing access to one or more resources accessible via a remote computer. The resources are assigned to a remote security context. Access to at least one of said remote resources within the remote security context is controlled by access rules that are valid for said at least one of said remote resources, on receipt of a terminal services request for a terminal session from a local computer. A user of said local computer has already been authenticated in a local security context by local authentication information. The local computer runs a local agent and contains identification information in addition to the local authentication information. The method involves obtaining at least said identification information from said local agent; performing access control to said at least one of said remote resources using said access rules on the basis of at least said identification information, and providing access for said local computer to said at least one of said remote resources for which said access rules permit access.

### FIELD OF THE INVENTION

The invention relates to methods, computer programs and a system for providing access from a local computer to a remote computer. In particular, the invention relates to such methods, computer programs and a system using terminal services delivered by a remote computer to a local computer.

### BACKGROUND

In computing, recent years have shown a trend of creating increased flexibility of applications, networks and operating systems, by means of so-called “virtualization”. In computing, virtualization is the process of presenting a logical grouping or subset of computing resources so that they can be accessed in ways that give benefits over the original configuration. This new virtual view of the resources is not restricted by the implementation, geographic location or the physical configuration of underlying resources. Commonly virtualized resources include applications, networks and operating systems.

Terminal services, such as those offered by operating systems like Windows® XP and Windows® 2003, enable access to any application or other resource on a remote computer from a local computer that is communicatively connected to the remote computer.

In order to be able to restrict access to applications and other resources, it is common to assign security contexts to the resources. Before a person is able to access the resources assigned to a specific security context, authentication for that security context is required, e.g. by providing a username and password. In addition to the authentication of the user, it is determined to which resources in the security context the user will have access, and/or what kind of access (e.g., read, write or execute of a data file).

At present, each time when a user, who has already been authenticated in the security context of the local computer, desires to access a resource in a different security context for the first time in the current session of a terminal service, authentication information should be supplied for the different security context. The information may either be explicitly input by the user or be implicitly passed on by her computer. Explicitly inputting such information by the user in each new security context, implies that the user has to spend much effort in providing information. Implicitly passing on such information from one security context to another, requires that the two security contexts need to ‘trust each other’. In order to realise this, such trusts are created between the security contexts, which requires significant effort from IT-staff.

The updating of authentication information becomes especially laborious when many users have dynamically changing needs for resources, e.g. typically use a specific resource in a remote security context only a few times, possibly during a few weeks, before moving on to other security contexts.

Additionally, the access to resources is linked in a fixed manner to authentication, meaning that when a person is authenticated for a security context, it is therewith also determined to which resources she is given access. This means that there is little flexibility in changing the access allowed for different resources.

### SUMMARY OF THE INVENTION

An object of the invention is to reduce the amount of effort required to provide authentication for and access to resources in different security contexts in the context of terminal services.

A further object of the invention is to increase the flexibility of providing access to remote resources.

These goals are realized by the methods according to independent claims 1, 10 and 13, the computer programs according to independent claims 14 and 16, and the computer system according to independent claim 18.

The methods provide for single sign-on on the basis of automatic propagation of identification information. This means that the user signs in on a local security context and then is authenticated and given access to applications in one or more remote security contexts without having to perform authentication procedures.

Moreover, the inventors have realised that decoupling of authentication and access provides a greater flexibility in the granting of access to resources, in that it becomes possible to assign different levels of access to each resource in a security context without having to specify such access explicitly for each individual user to each individual resource.

It should be appreciated that authentication information differs from identification information. For instance, usually authentication information comprises a user's logon name and a logon password, and identification information may comprise such information as the organisation and department to which that user belongs. The information collected and provided by the local agent to the remote computer system is at least the identification information, and may comprise authentication information as well.

In the methods according to the invention, the access rules permit access on the basis of the identification information, possibly in combination with some or all of the authentication information. For instance, if a user belongs to a specific organisation and department, only access to the application programs may be provided that were hired by that organisation for that department. In this manner, it is no longer necessary to store per user which access is permitted, but this access can be defined in a decision rule which pertains to the entire department in the organisation, which implies a reduction of the amount of administrative work.

Or, alternatively, if the access information was not managed by the IT-staff but instead input by the user, the user does no longer have to input the various access data each time, and as such is released from the effort.

The obtaining of identification information according to the methods of the invention, by the remote terminal server from the local agent program, being a grouping of information that is tailored to a specific user or group of users, may be regarded as ‘user [data] virtualization’. This kind of virtualization supplements the kinds mentioned before.

An embodiment of the invention is defined in claims 2 and 3. In this embodiment, even more information can be used with little effort.

Another embodiment of the invention is defined in claim 4. In this embodiment, the remote computer has to collect the identification information only once from the local computer in each terminal session, even when various security contexts are to be accessed.

Another embodiment of the invention is defined in claim 5. This embodiment takes away the need to collect the defined information items at each new terminal session. This may be beneficial in situations where e.g. the preference information does not change often. If the user identification is also a globally unique identification, the information in the database may be used each time the user logs on, from any local computer in the world, without confusing the user for someone else.

Another embodiment according to the invention is defined in claim 7. This embodiment allows for an easy updating of the information that changes every now and then, and helps to keep the storage space of the remote server clean.

Two embodiments of the method according to the invention are defined in claims 8 and 9. The Windows® GINA process or an equivalent thereof, offers the possibility of adding additional layers of functionality to the authentication process, which then are used to pass on the identification information. Moreover, the RDP- and ICA-clients, respectively communicating via an RDP- and ICA-protocol, make the use of a virtual data channel relatively easy, which data channel then is used together with the GINA process or an equivalent thereof, to pass on information, such as the identification information.

The other methods, computer programs and systems according to the invention as defined in the claims offer all or at least some of the advantages described above for the claims 1-9.

The invention will hereafter be described on the basis of the accompanying drawings, schematically showing embodiments of the invention. It will be clear that the invention is in no manner limited by these examples of embodiments.

### SHORT DESCRIPTION OF DRAWINGS

In the figures:

FIG. 1 is a block schema of an embodiment of a computer system according to the invention,

FIG. 2 is a process schema, illustrating an embodiment of the method according to the invention, and

FIG. 3 is a block schema of security contexts and resources, as may be used by methods, programs and system according to the embodiments of the invention.

### DETAILED DESCRIPTION OF DRAWINGS

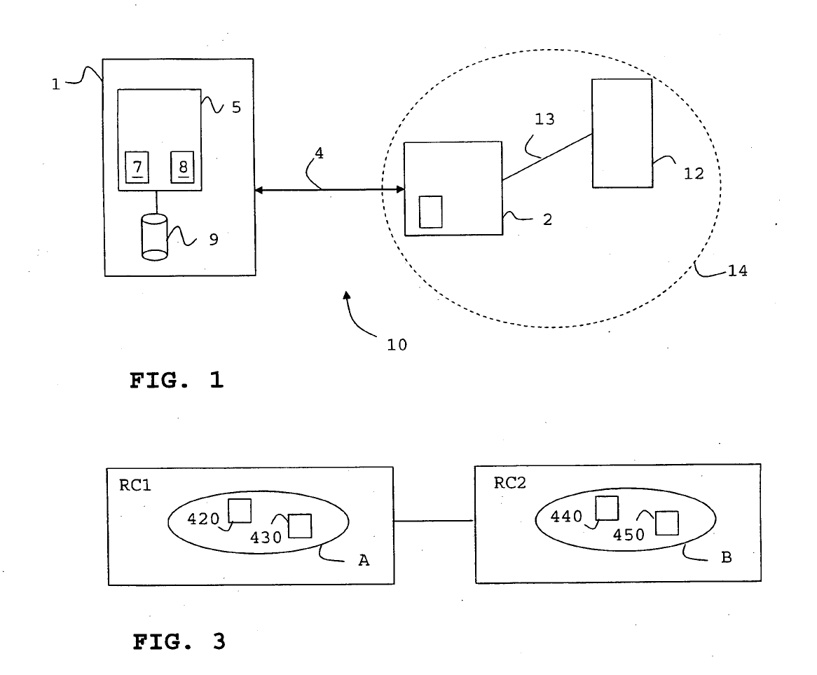

FIG. 1 shows a computer system 10, comprising a remote computer system 1, a local computer 2 and a data communication network 4. The remote computer system 1 runs the operating system Windows® 2003 and has available a Windows® terminal server program stored on storage means 5 thereof. The terminal server program is capable of providing a terminal service to the local computer 2. The local computer 2 uses a server 12, that is part of the local computer's operating system and accessible via a communication link 13 formed by the local computer's bus connection. In an alternative embodiment, the server 12 is external to the local computer 2 and the communication link 13 is formed by a local communication network.

The local computer 2 and server 12 are assigned to a shared local security context 14. Simultaneously, at least one of the local computer 2 and server 12 may be assigned to other local security contexts as well.

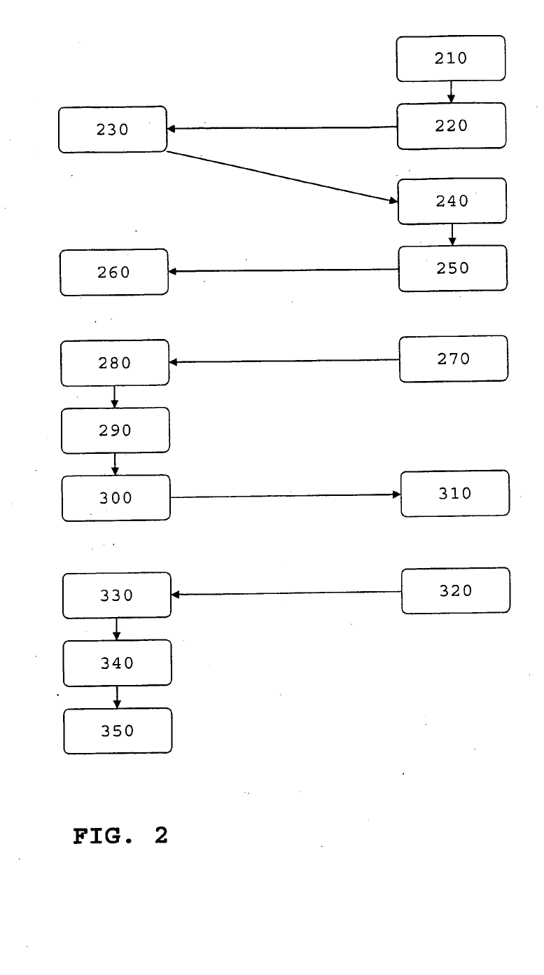

The local computer 2 and the remote computer system 1 are connected via the data communication network 4. The remote computer system 1 has resources 420, 430, 440, 450 available (see FIG. 3), such as a processor, memory and storage space, and application programs or other data stored in the storage means 5. The resources on the remote computer system 1 are e.g. assigned to two security contexts A and B (see FIG. 3) of the remote computer system 1, on remote computer RC1 and remote computer RC2. The access to these remote security contexts is controlled by access rules, indicated by block 7 in FIG. 1, which rules 7 are available for the remote computer system 1 and incorporated in a computer program that performs access control and runs e.g. on the remote computer 1, when the remote computer system 1 receives a terminal services request for a terminal session from the local computer 2. This access control by the rules is done on the condition that the local computer 2 is already authenticated in the local security context 14 by having provided local authentication information and that a local agent 6 is running on the local computer 2. The terminal server program of the remote computer system 1 performs, in cooperation with the local agent program 6 on the local computer 2, the steps shown in FIG. 2. FIG. 1 also shows a temporarily existing data object 8 stored on the remote computer system 1, which data object 8 is used for storing e.g. identification information, user preference information and configuration information, as will be further described below. The remote computer system comprises a relational database management system 9.

FIG. 2 shows, by way of example, the steps performed in a method according to an embodiment of the invention. It is assumed that the resources of the remote computer systems have already been assigned to remote security contexts, as described above.

In FIG. 2, the arrows indicate the order of the steps. On the left hand side of FIG. 2, the steps performed by the remote computer system 1 are shown and on the right hand side the steps performed by the local computer 2 are shown.

First, in step 210, a user who logs on at the local computer 2, is authenticated by that computer 2 in a local security context 14 thereof. Often, though not necessarily, this occurs immediately on starting up of the computer 2. Then, possibly after having done other things first, the user sends a request for a terminal session to the terminal server program 5 running on the remote computer system 1, in step 220. Upon receiving that request, in step 230, the remote computer system 1 initiates a terminal session and initiates the local agent 6 on the local computer 2.

In this example of the invention, the terminal server program 5 starts a Windows® GINA (graphical identification and authentication) process, which type of process serves to identify and authenticate the user. Usually the latter is done by means of a logon window on the user's computer monitor, but the Windows® GINA process allows for additional layers of functionality, that, in the present embodiment of the invention, are used to pass on authentication and identification information. Moreover, in the shown embodiment of the invention, the Windows® RDP-protocol is used for the communication between the remote computer system 1 and the local computer 2. This protocol allows for setting up of a virtual communication channel in addition to the communication channel used for passing on the information common to terminal services, i.e., keystroke information, mouse information and terminal screen information. The virtual channel is used in the present embodiment of the invention to pass on identification information, as described below. As an alternative to Microsoft's RDP-protocol, another protocol may be used, such as Citrix's ICA-protocol.

The local agent 6 then starts running, in step 240. It will be understood by the person skilled in the art that the local agent may alternatively be initiated by the local computer 2, upon sending the request for a terminal session, i.e. the local agent 6 is not initiated by the remote computer system 1.

When running, the local agent 6 collects, in step 250, authentication information, comprising a part of the local authentication information, in the form of a local user identity (user_id) that was also used by the user for authenticating on the local computer (in combination with a password), as well as identification information comprising e.g. identifications of the user's organisation and department in the organisation. Then, still in step 250, the local agent passes the collected authentication information collected on to the remote computer system 1, via the virtual channel set up according to the RDP-protocol.

Although this is not the case in the example, the identification information may comprise data items that are more difficult to manipulate for unauthorized persons, such as a certificate serving as a digital signature or biometrical data, e.g. as obtained from an iris scan.

In addition to the identification information, configuration information for the resources for the user or a group of users may be passed on from the local computer 2 to the remote computer 1, as well as preference information for a user or a group of users. The preference information is intended for altering the settings of the application programs according to the preferences of a user or group of users.

In step 260, the remote computer system 1 retrieves the identification information collected by the local agent 6. In other embodiments, the remote computer system 1 may receive the identification information sent by the local agent 6.

Next, when the user wants to access a resource, a request to access this resource is sent to the remote computer system 1, in step 270, which system 1 reacts, in steps 280 and 290, by performing access control using the identification information obtained in step 26 and deciding whether or not to provide access to the resource requested, by using access rules and information in an avatar 8 in the manner described below with reference to FIG. 3. The access rules may use identification information additional to the organisation and department identifications, such as iris scan data present in the avatar. If access is to be provided, the remote computer system 2 creates a temporary user account, in step 300, based on data present in the avatar 8, which contains the user_id (part of the local authentication information), as well as the identifications of the organisation and department (identification information).

In other embodiments of the invention, such as those in which the remote computer system 1 is connected to the internet, and hence may communicate to each local computer 2 also connected to the internet, it is beneficial to store in the avatar as user identification a global identification, i.e. an identification that is globally unique to the relevant part of the population of the world (e.g., those connected to the internet and being users of the terminal services of the remote computer system 2). Although usually the user_id sent obtained from the local agent 6 will not be a global identification, that user_id may be associated uniquely to a global identification present in the avatar. The same holds, mutatis mutandis, for the organisation identification and department identification.

After providing access, the user accesses the required resource, in step 310.

Then, when finished using the resources, the user sends a request for ending the terminal session to the remote computer system 1 from the local computer 2 in step 320. The remote computer system 1 reacts by storing the user identification, configuration information and user preference information in the relational database management system 9 (See FIG. 1).

Finally, in steps 340 and 350, the avatar 8 is deleted and the terminal session is ended, respectively.

On the basis of FIG. 3, it will now be described how access rules are used for providing access to remote resources in remote computers RC1, RC2. The remote computer RC2 is communicatively connected to the remote computer RC1. The computer RC1 comprises two resources 420 and 430, that have been assigned to a remote security context A. The computer RC2 comprises two resources 440 and 450, both assigned to a remote security context B. In this example, the resources 420 and 430 are application programs, whereas the resources 440 and 450 comprise storage disk space organised into file directories.

When the terminal server program of the remote computer RC1 receives a request for access to one of these resources from a user, in the situation wherein that user has already been authenticated on the local computer 2, the terminal server program performs access control for the user, which means that it checks, on the basis of access rules, whether the user will be allowed to access the resource required. In this example, the local agent has collected information regarding the organisation and department of the user from a local computer 2. Also, in this example, one access rule is present on the remote computer RC2, which rule may be formulated as follows:

IF organisation=RES

AND department=R&D

THEN access=allowed

In this example, the access rule is formulated having a conditional part, or “IF”-part, which contains conditions, and a conclusion/action-part, or “THEN”-part. It is noted that the rule may be formulated in alternative ways than shown, as long as it is formulated such that it can be processed by the remote computer system 1 for performing access control. It should be appreciated that the access rules may be more complicated and that more than one access rule may be applied.

Suppose that the user belongs to the organisation YYY Inc., and the department R&D thereof, and the user sends a request for accessing resource 450. Using the access rule above, the remote computer RC1 then decides that no access is to be given, since the information on the user, as collected by the local agent 6 and stored in the avatar 8, does not meet the two conditions of the access rule, and therefore the conclusion part is not made true, i.e., the parameter “access” is not assigned any value representing a resource.

Now suppose that the user belongs to the organisation RES, and the department R&D thereof, and the user sends a request for accessing resource 430. Using the access rule above, the remote computer system RC1 then decides that the information on the user meets the two conditions of the access rule, and makes the conclusion part true, i.e., assigns the parameter “access” the value “allowed”.

The shown examples are given only for illustrative purposes, and are not to be taken as limitative. For instance, the remote computer system may run on a different operating system than Windows®, such as Unix. Various other modifications are possible, without leaving the scope of the invention, as defined in the following claims.

1. A method of providing access to one or more resources accessible via a remote computer, said resources being assigned to a remote security context, wherein access to at least one of said remote resources within said remote security context is controlled by access rules, valid for said at least one of said remote resources, on receipt of a terminal services request for a terminal session from a local computer, a user of said local computer being already authenticated in a local security context by local authentication information, said local computer running a local agent and containing identification information in addition to the local authentication information, said method comprising the steps at the remote computer of:
obtaining at least said identification information from said local agent;
performing access control to said at least one of said remote resources using said access rules on the basis of at least said identification information, and
providing access for said local computer to said at least one of said remote resources for which said access rules permit access.

2. The method according to claim 1, wherein the method also comprises the step by the remote computer of obtaining user preference information stored on or accessible by the local computer, which user preference information defines preferences of the user, or a group of users, with respect to the manner of using the resources.

3. The method according to claim 1, wherein the method also comprises the step by the remote computer of obtaining configuration information stored on or accessible by the local computer, which configuration information defines the configuration settings of the resources for the user or a group of users.

4. The method according to claim 3, wherein the remote computer creates and stores a data object upon obtaining the identification information, in which data object one or more of the local authentication information, the identification information, the user preference information and the configuration information is stored.

5. The method according to claim 4, wherein, on ending the terminal session, the remote computer stores at least a user identification and one or more items of the preference information and configuration information in a database system.

6. The method according to claim 5, wherein the user identification is a global identification.

7. The method according to claim 4, wherein, on ending the terminal session, the remote computer deletes the data object.

8. The method according to claim 1, wherein the terminal session uses a Windows® graphical identification and authentication process, or an equivalent successor of such a Windows® graphical identification and authentication process, for the communication between the remote computer and the local agent.

9. The method according to claim 1, wherein the local agent is an RDP-client program or an ICA-client program.

10. A method of obtaining access on a local computer to one or more resources accessible via a remote computer, said resources being assigned to a remote security context, wherein access to at least one of said resources within said remote security context is controlled by access rules valid for said at least one of said resources, said method comprising the steps at the local computer of:
authenticating a user of said local computer in a local security context by local authentication information, said local computer containing identification information in addition to the local authentication information;
sending a terminal services request for a terminal session;
collecting and providing at least said identification information to said remote computer, by a local agent running on the local computer, and
obtaining access by said local computer to said at least one remote resource for which said access rules permit access as determined on the basis of at least said provided identification information.

11. The method according to the claim 10, wherein the method also comprises the steps by the local agent of collecting and providing to the remote computer of user preference information stored on or accessible by the local computer, which user preference information defines preferences of the user or a group of users with respect to the manner of using the resources.

12. The method according to claim 10, wherein the method also comprises the step of by the local agent of collecting and providing to the remote computer configuration information stored on or accessible by the local computer, which configuration information defines the configuration settings of the resources for a user or a group of users.

13. A method of providing access on a local computer to one or more resources accessible via a remote computer, said resources being assigned to a remote security context, wherein access to at least one of said resources within said remote security context is controlled by access rules valid for said resources, said method comprising the steps of:
authenticating a user of said local computer in a local security context by local authentication information, said local computer containing identification information in addition to the local authentication information;
sending a terminal services request for a terminal session by said local computer;
collecting and providing at least said identification information to said remote computer by a local agent running on said local computer;
performing access control to said at least one resource using said access rules on the basis of at least said identification information by said remote computer; and
providing access for said local computer to said at least one resource for which said access rules permit access by said remote computer.

14. A computer program for providing access to one or more resources accessible via a remote computer, said resources being assigned to one or more remote security contexts, wherein access to at least one of said remote resources within said remote security context is controlled by access rules valid for said at least one remote resource on receipt of a terminal services request for a terminal session from a local computer, a user of said local computer being already authenticated in a local security context by local authentication information, said local computer running a local agent and containing identification information in addition to the local authentication information, said program being capable of running at a remote computer and comprising computer-readable instructions for performing the tasks of:
obtaining at least said identification information from said local agent;
performing access control to said at least one resource using said access rules on the basis of at least said identification information; and
providing access for said local computer to said at least one resource for which said access rules permit access.

15. The computer program according to Wclaim 14, further comprising computer-readable instructions for performing the tasks of claim 2.

16. A computer program for obtaining access on a local computer to one or more resources accessible via a remote computer, said resources being assigned to a remote security context, wherein access to at least one of said remote resources within said remote security context is controlled by access rules valid for said at least one remote resource, said program being capable of running at a local computer and comprising computer-readable instructions for performing the tasks of:
authenticating a user of said local computer in a local security context by local authentication information, said local computer containing identification information in addition to the local authentication information;
sending a terminal services request for a terminal session,
collecting and providing at least the identification information to said remote computer by a local agent running on the local computer, and
obtaining access by said local computer to said at least one resource for which said access rules permit access as determined on the basis of at least said provided identification information.

17. The computer program according to the claim 16, further comprising computer-readable instructions for performing the tasks of claim 11.

18. A remote computer system arranged for providing terminal services to at least one local computer, on which remote computer system a terminal server program is available, which terminal server program is capable of providing a terminal service to the local computer, whereby the terminal server program, on execution, provides access to one or more resources, said resources being assigned to a remote security context, wherein access to at least one of said remote resources within said remote security context is controlled by access rules, valid for said at least one remote resource, on receipt of a terminal services request for a terminal session from a local computer, a user of said local computer being already authenticated in a local security context by local authentication information and said local computer running a local agent and containing identification information in addition to the local authentication information, said terminal server program, on execution, being capable of executing the steps of
obtaining at least said identification information;
performing access control to said at least one remote resource using said access rules on the basis of at least said identification information, and
providing access for said local computer to said at least one of said remote resources for which said access rules permit access as determined on the basis of at least said provided identification information.

19. The remote computer system according to claim 18, wherein said terminal server program, on execution, is further capable of executing the steps of claim 2.

20. The method according to claim 1, wherein the method also comprises the step by the remote computer of obtaining configuration information stored on or accessible by the local computer, which configuration information defines the configuration settings of the resources for the user or a group of users.
